(19) United States
(12) Patent Application Publication
(10) Pub. No.: US 2001/0051090 A1
(43) Pub. Date: Dec. 13, 2001

(54) Material transport apparatus

(76) Inventor: Gary L. Johnston, Cowarts, AL (US)

Correspondence Address: Gary Johnston, P.O. Box 183, Cowarts, AL, 36321, US

(21) Appl. No.: 09/725,773

(22) Filed: Nov. 29, 2000

Related U.S. Application Data
(63) Continuation-in-part of application No. 09/505,799, filed on Feb. 17, 2000.

(51) Int. Cl. B62B 1/00

(52) U.S. Cl. 414/469

(57) ABSTRACT

A material transport apparatus is provided which enables an operator to load, transport, and unload material while moving the apparatus in the forward and backward directions. The apparatus includes a frame structure means, a material handling means, and a power transfer means, with the material handling means and the power transfer means being mounted on the frame structure means. The material handling means is pivotally mounted to the frame structure means, and its open end may thus be pivoted in the forward and backward directions via the power transfer means. An optional item may include an attachment component for attaching the apparatus to a piece of construction or farm equipment. The apparatus may also be part of a motorized vehicle, whose primary purpose is to load, transport, and unload material.

### CROSS REFERENCE TO RELATED APPLICATIONS

This application is a Continuation-In-Part of U.S. patent application Ser. No. 09/505,799, filed Feb. 17, 2000.

### BACKGROUND OF THE INVENTION

This invention relates to a material transport apparatus which may be used to load and unload material in both the forward and backward directions. The are instances where material, such as soil, rock, debris, etc., may need to be transported from one location to another. This device allows an easy way for the material to be loaded, transported, and then unloaded. Given the fact that there is a large number of construction and farm equipment available in the marketplace, it has come as a surprise that no one has developed an easy and effective piece of equipment which allows material to be easily loaded and unloaded in both the forward and backward directions.

### SUMMARY AND OBJECTS OF THE INVENTION

It is the object of this invention to provide a material transport apparatus which may be easily used to load, transport, and unload material from one location to another. The main purpose of this application is to demonstrate an apparatus which performs the stated function, and to demonstrate the many options and configurations this apparatus may take on.

Briefly stated, the apparatus that forms the basis of the present invention comprises a frame structure means, a material handling means, and a power transfer means. The material handling means and the power transfer means are mounted upon the frame structure means. The frame structure means may also include an attachment component for attaching the apparatus to a motorized piece of equipment, such as a farm tractor, bull dozer, dump truck, etc. Alternately, the apparatus may be a built-in component of a motorized vehicle whose primary purpose is to load, transport, and unload material.

The design of the apparatus is such that the material handling means is pivotally mounted on the device frame, and the power transfer means is used to pivotally move the material handling means in both the forward and backward directions. The power transfer means may itself be rigidly mounted to the frame structure means, with a portion pivoting in the upward and downward directions. Alternately, the entire power transfer means may be pivotally mounted to the frame structure means and pivotally move in the upward and downward directions. In either instance, material may be loaded into the material handling means while the apparatus is being pulled or pushed, with the material handling means of the apparatus positioned in preferably the forward direction when pulled, and the backward direction when pushed. The material handling means of the apparatus may also be positioned upright so that the material is collected within the material handling means. The material may then be transported to another location, and unloaded, in either the forward or backward directions. Other objects, features, and advantages for this invention will be apparent from the following detailed description and the appended claims, references being made to the accompanying drawings forming a part of the specification, wherein like reference numerals designate corresponding parts of the several views.

### BRIEF DESCRIPTION OF THE DRAWINGS

FIG. 1A is a side view of the material transport apparatus.

FIG. 1B is a top view of the material transport apparatus.

FIG. 1C is a front view of the material transport apparatus.

FIG. 2A is a side view of the frame structure means of the material transport apparatus.

FIG. 2B is a top view of the frame structure means of the material transport apparatus.

FIG. 2C is a front view of the frame structure means of the material transport apparatus.

FIG. 3A is a side view of the power transfer means of the material transport apparatus.

FIG. 3B is a top view of the power transfer means of the material transport apparatus.

FIG. 3C is a front view of the power transfer means of the material transport apparatus.

FIG. 4A is a side view of the material handling means of the material transport apparatus.

FIG. 4B is a top view of the material handling means of the material transport apparatus.

FIG. 4C is a front view of the material handling means of the material transport apparatus.

FIG. 5A is a side view of the material transport apparatus loading and unloading material in the forward direction.

FIG. 5B is a side view of the material transport apparatus loading and unloading material in the backward direction.

FIG. 5C is a side view of the material transport apparatus with the material handling means is in the upright direction.

FIG. 6 is a side view of an alternative mounting configuration for the power transfer means.

FIG. 7 is a side view of the material transport apparatus with an optional wheel attachment.

FIG. 8 is a side view of the material transport apparatus demonstrating its attachment to a tractor.

### DETAILED DESCRIPTION OF THE PREFERRED EMBODIMENT

Before explaining in detail the present invention, it is to be understood that the invention is not limited in its application to the details of construction or arrangement of parts illustrated in the accompanying drawings, since the invention is capable of other embodiments and of being practiced or carried out in various ways. Also, it is to be understood that the phraseology and terminology employed herein is for the purpose of description, and not limitation.

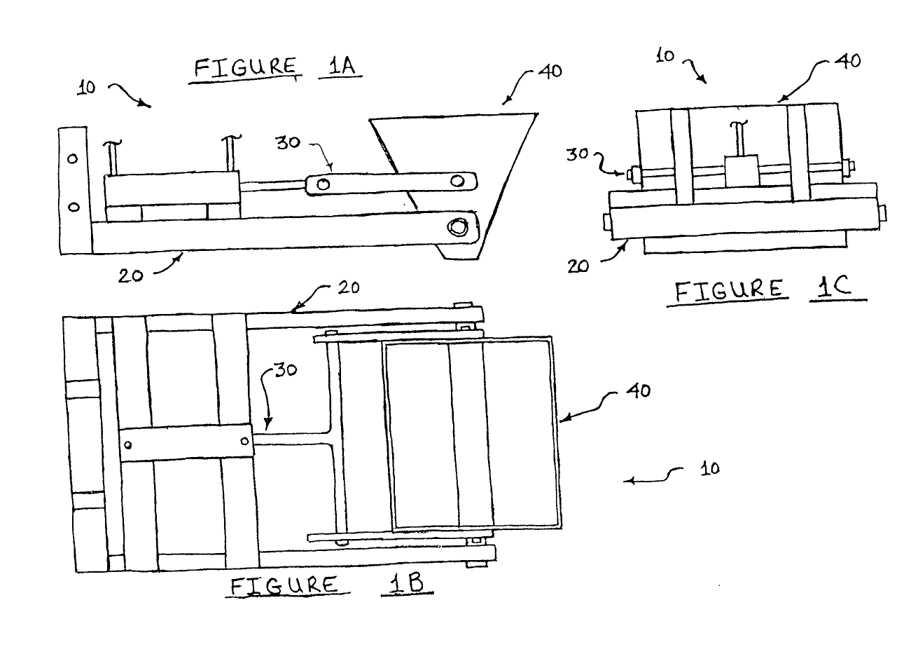

As best can be seen by references to the drawings, and in particular to FIGS. 1A-1C, the material transport apparatus that forms the basis of the present invention is designated generally by the reference numeral 10, and includes a frame structure means 20, a material handling means 40, and a power transfer means 30. The power transfer means 30 and the material handling means 40 are mounted on frame structure means 20.

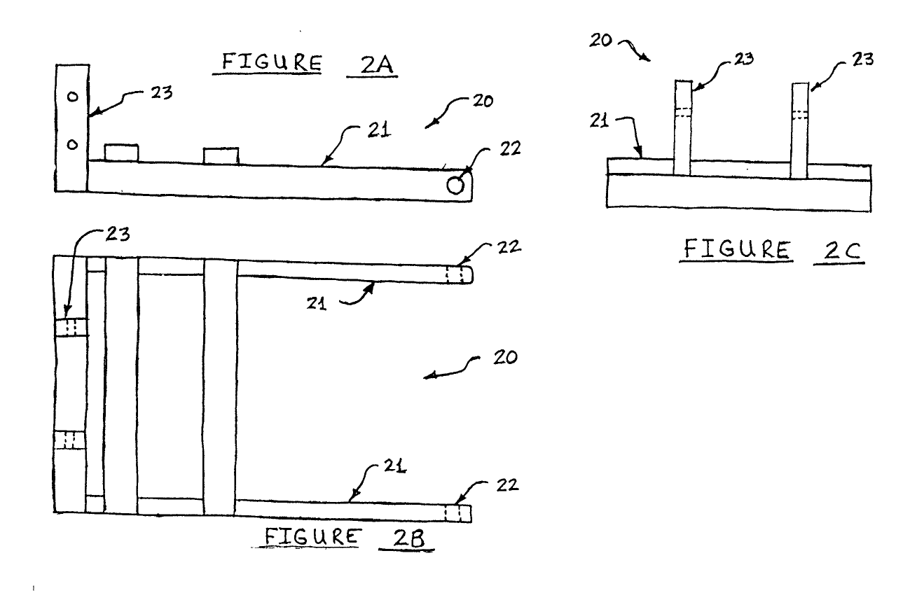

As may be seen in FIGS. 2A-2C, the frame structure means 20 comprises a base 21 with base openings 22, and attachment component 23. Base 21 is used to support power transfer means 30. Material handling means 40 pivotally mounts on base 21 through base openings 22. Attachment component 23 is an item which may be used to mount the apparatus to a motorized vehicle, such as a farm tractor. As previously stated, the apparatus may also be a built-in component of a motorized vehicle, whose primary purpose is to load, transport, and unload material.

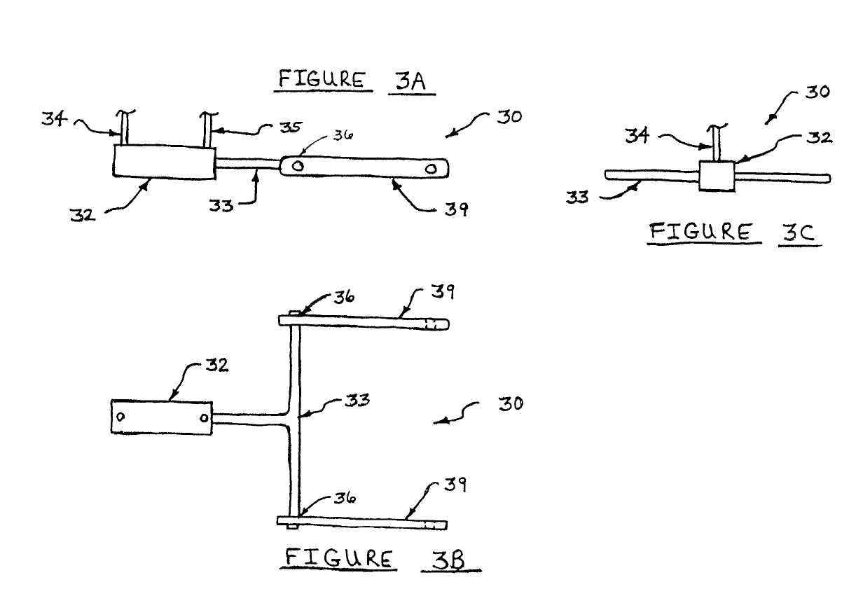

As may also be seen in FIGS. 3A-3C, the power transfer means 30 may comprises a power component 31 and linkage members 39. Power component 31 is a typical cylinder-actuator type power component well know in the industry, and is comprised of air-tight cylinder 32, actuator 33, first tube 34, and second tube 35. In this particular design, cylinder 32 is rigidly mounted to base 21, while linkage member 39 is pivotally mounted at one end to actuator 33, through linkage openings 36. As will be shown later, other configurations are possible.

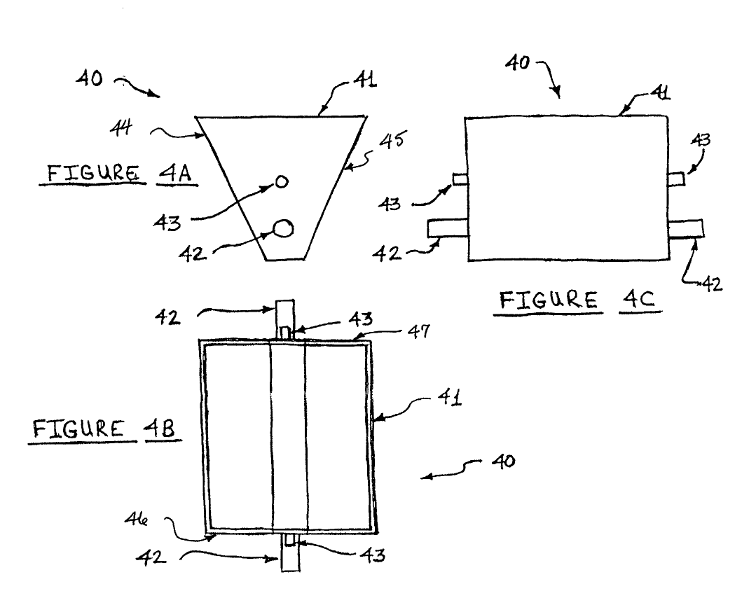

As may be seen in FIGS. 4A-4C, the material handling means is comprised of a handling component 41 with pivot members 42 and engagement members 43. Handling component 41 is a typical load bucket commonly found on many types construction equipment, such as a front end loader. As shown, it has a front 44, a back 45, a right side 46, a left side 47, and a bottom 48. The top is open so material may be loaded and contained within. Pivot members 42 are used to pivotally mount the handling component to structure frame means 20, while engagement members 43 are used to pivotally mount linkage member 39 of power transfer means 30 to the handling component 41.

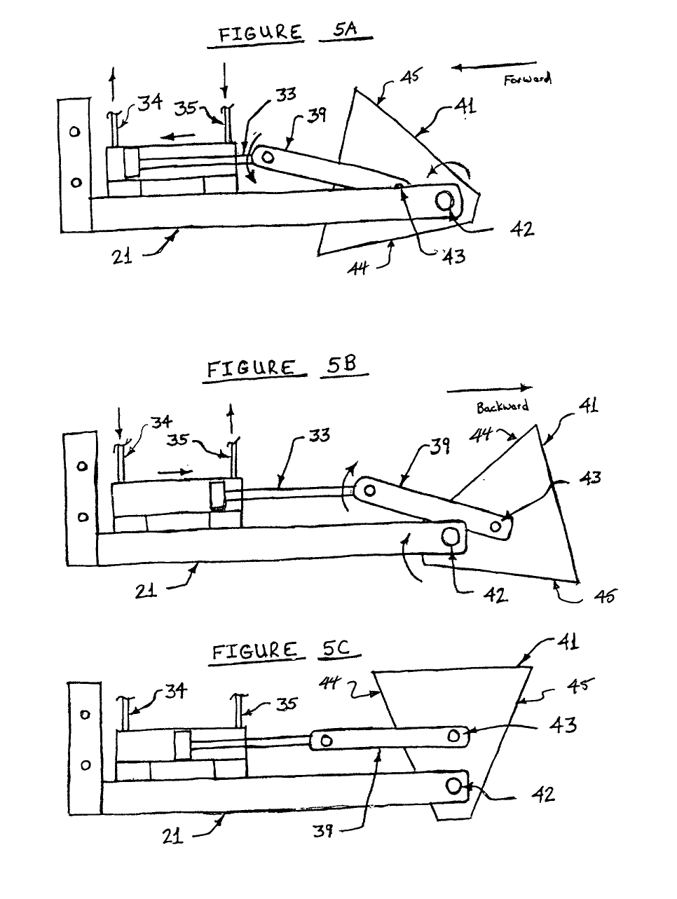

The operation of the material handling apparatus 10 may be seen in FIGS. 5A, 5B, and 5C. As may be seen in FIG. 5A, the first tube 34 and second tube 35 may connect to the hydraulic supply of a piece of farm or construction equipment, such as a farm tractor. Hydraulic fluid may be pumped into the cylinder 32 through second tube 35, and out of first tube 34, causing the actuator 33 to move in the forward direction. The actuator 33 will pull linkage members 39 in the forward direction. Since linkage members 39 are pivotally connected to handling component 41 through engagement members 43, and handling component 41 is pivotally mounted to base 21, handling component 41 will then pivot in the forward direction. As material, such as soil, rock, and debris, come in contact with the front 44 of handling component while in this position, and with the apparatus moving forward, some of the material will begin loading into the hollow portion 49 of handling component 41.

As may be seen in FIG. 5B, hydraulic fluid may also be pumped into the cylinder 32 through first tube 34, and out of second tube 35, causing the actuator to move in the backward direction. The actuator 33 will push linkage members 39 in the backward direction. Again, since linkage members 39 are pivotally connected to handling component 41, handling component 41 will pivot in the backward direction. As material, such as soil, rock, and debris, come in contact with the back 45 of handling component 41 while in this position, and with the apparatus moving backward, some of the material will begin loading into the hollow portion A of handling component 41.

As may be seen in FIG. 5C, hydraulic fluid may be added to and removed from the cylinder so that the actuator is in a relatively middle position. This will result in handling component 41 being positioned relatively upright, allowing the material being loaded to be contained within the handling component and transported to a different location. Once at the new location, the material may then be unloaded by positioning the material handling component in one of the positions shown in FIGS. 5A and 5B, depending upon which direction of unloading is preferred.

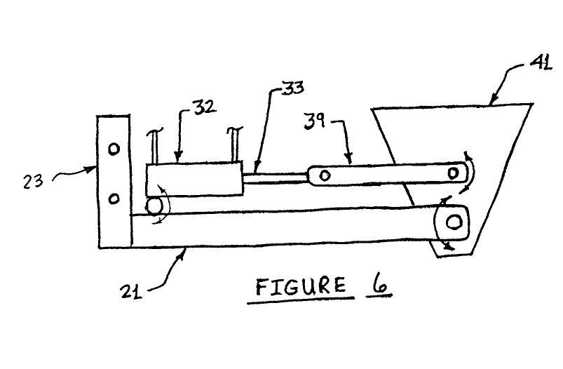

FIG. 6 demonstrates another mounting configuration for the power transfer means 30. Shown in previous diagrams is a cylinder 32 rigidly mounted to base 21, with a linkage member 33 pivotally mounted to the cylinder actuator 33. In this alternative configuration, the cylinder 33 is itself pivotally mounted to base 21, with linkage member 33 now rigidly mounted to actuator 33. In this configuration, the entire power transfer means 30 pivots in the upward and downward directions, while before, only the linkage member 33 pivoted in the upward and downward directions. Therefore, it may be said that in both configurations, at least a portion of the power transfer means 30 may pivot in the upward and downward directions.

Various stops or blocks may be mounted on the frame structure means 20 for limiting the amount of pivot by handling component 41. Also, any type of braking system well-known in the industry may be used in conjunction with the linkage member 39 or pivot member 42 to limit the amount of pivot.

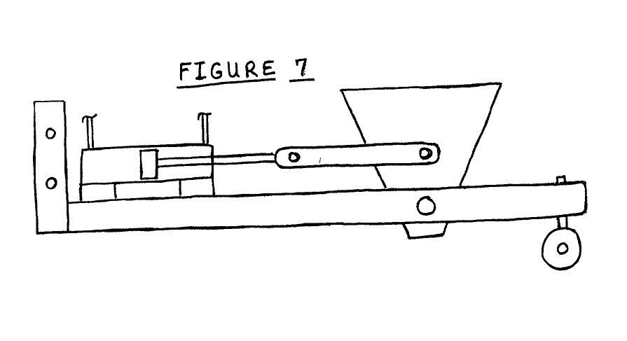

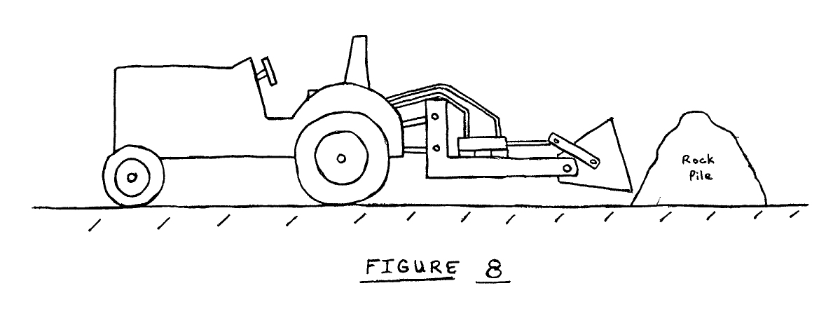

FIG. 7 demonstrates an optional wheel attachment which may be used to help balance the apparatus. FIG. 8 demonstrates the apparatus being attached to a tractor. The attachment component 23 may be constructed so that it attaches to the lift component of the tractor, allowing the apparatus to be lifted upward and downward during it use. It may also mount to other types of motorized vehicles, or be a feature of a motorized unit whose sole purpose is to load, transport, and unload material. As shown, the apparatus functions much in the same way as other types of loading equipment, such as a front end loader. However, the uniqueness of this device lies in its ability to load material in both the forward and backward directions, and also unload material in both the forward and backward directions. Front end loaders only load and unload in one direction, and the handling component, or bucket, is mounted to the front of the equipment. The preferred mounting location for this apparatus is to the rear of the equipment.

Many variations of the material handling apparatus exist, along with the configurations described above. Instead of a double-acting cylinder, two single-acting cylinders could be used, one to pivot the handling component in the forward direction, and one to pivot the handling component in the backward direction. Also, multiple cylinders could be used in conjunction with one another, one interacting with the right side of the handling component, and one interacting with the left side of the handling component. Also, the cylinder and actuator could be pneumatic instead of hydraulic. And, there are other types of power components, other than the cylinder-actuator system shown, which could perform the same function. A system could be designed which operates off the power take-off system of a piece of farm or construction equipment. While it will be apparent that the preferred embodiment of the invention herein disclosed is well calculated to fulfill the objects above stated, it will be appreciated that the invention is susceptible to modification, variation, and change without departing from the proper scope or fair meaning of the subjoined claims.

I claim:

1. A material transport apparatus comprising:
a frame structure means;
a material handling means;
a means for pivotally mounting said material handling means upon said frame means;
a power transfer means operatively connected to said material handling means for pivoting said material handling means in the forward and backward directions;
a power transfer mounting means for mounting said power transfer means upon said frame means;
whereby material may be loaded into the material handling means while the open end of the material handing means is pivoted in the substantially forward direction and the apparatus is moving in the forward direction, material may also be loaded into the material handling means while the open end of the material handing means is pivoted in the substantially backward direction and the apparatus is moving in the backward direction, and material may be selectively unloaded from the material handling means in either the forward or backward direction.

2. The material transport apparatus as claimed in claim 1, said means for pivotally mounting said material handling means upon said frame means including openings located on said frame means, and at least one pivot member mounted upon said material handling means, said pivot member turnably mounted in said opening of said frame means.

3. The material transport apparatus as claimed in claim 1, said frame structure means further comprising an attachment component for attaching said apparatus to a motorized vehicle.

4. The material transport apparatus as claimed in claim 1, said material handling means comprising;
a handling component used to collect and transport material;
at least one engagement member used to operatively connect said handling component and said power transfer means.

5. The material transport apparatus as claimed in claim 1, said power transfer means comprising;
a power component rigidly mounted to said frame structure means through said power transfer mounting means;
at least one linkage member pivotally connected at one end to said power component, and pivotally connected at the opposite end to at least one side said material handling means.

6. The material transport apparatus as claimed in claim 5, said power component of said power transfer means comprising;
at least one cylinder and actuator, said actuator pivotally mounted to said linkage member, whereby;
said cylinder, said actuator, and said linkage member are used to pivot said material handling means in the forward and backward directions.

7. The material transport apparatus as claimed in claim 1, said power transfer means pivotally mounted to said frame structure means at one end through said power transfer mounting means, and pivotally mounted at its opposite end to said material handling means.

8. The material transport apparatus as claimed in claim 7, said power transfer means comprising;
at least one cylinder and actuator, said cylinder being pivotally mounted to said frame structure means,
at least one linkage member, said linkage member being rigidly mounted at one end to said actuator, and pivotally mounted at the opposite end to said material handling component, whereby;
said cylinder, said actuator, and said linkage member are used to pivot said material handling means in the forward and backward directions.

9. The material transport apparatus as claimed in claim 1, said power transfer means operatively connected to the hydraulic supply of a motorized vehicle.

10. The material transport apparatus as claimed in claim 1, said apparatus being part of a motorized vehicle.

11. The material transport apparatus as claimed in claim 1, said frame means further comprising a wheel attachment.
